(19) United States
(12) Patent Application Publication
(10) Pub. No.: US 2013/0229973 A1
(43) Pub. Date: Sep. 5, 2013

(54) BROADCAST RECEIVING DEVICE AND METHOD

(71) Applicant: Satoshi Hatamoto, Kanagawa (JP)

(72) Inventor: Satoshi Hatamoto, Kanagawa (JP)

(73) Assignee: PANASONIC CORPORATION, Osaka (JP)

(21) Appl. No.: 13/884,289

(22) PCT Filed: Nov. 25, 2011
(86) PCT No.: PCT/JP2011/006566

§ 371 Date: May 9, 2013

(30) Foreign Application Priority Data
Nov. 30, 2010 (JP) 2010-267075

(51) Int. Cl. H04H 20/95

(52) U.S. Cl. CPC H04H 20/95
USPC 370/312

(57) ABSTRACT

Data information sent from a broadcast station 40 is decoded by an RDS decoder 22 into character information and character position information indicating the positions of the character information, and the character information and character position information are associated with each other and stored in the RAM 32. A character information extraction unit 34 extracts the character information stored in the RAM 32 and displays the character information on a display unit 28. A character information comparison unit 36 reads out first character information included in the data information and second character information stored in the RAM 32, which has the same character position information as the first character information, and compares the first character information and second character information. If the first character information and second character information are different, the character information extraction unit 34 deletes the character information stored in the RAM 32.

### TECHNICAL FIELD

The present invention relates to a broadcast receiving device and method for receiving broadcast radio waves in which broadcast information and data information are multiplexed and effectively outputting and displaying the data information included in the broadcast radio waves.

### BACKGROUND ART

RDS (Radio Data System) that is defined as an FM radio standard allows transmission of data information (e.g., information such as a music name and an artist name) called Radio Text superimposed on broadcast information indicating the content of a broadcast program. A broadcast receiving device detects broadcast information and text information from received broadcast radio waves, and then outputs and displays the text information. With this system, for example, information such as the music name and artist name can be displayed on a monitor while the music is broadcasted.

RDS-compliant Radio Text can send information for 64 characters or 32 characters. Information for 64 characters is sent in pieces of data called groups 2A, each including text information for four characters, while information for 32 characters is sent in pieces of data called groups 2B, each including text information for two characters. That is, sending 16 group 2A data allows transmission of information for 64 characters, and sending 16 groups 2B data allows transmission of information for 32 characters. Group 2A data includes character position information indicating the position of corresponding four-character text, and the character position information allows a broadcast receiving device to arrange character information in an appropriate order.

In Radio Text Plus (RT+) as an advanced version of Radio Text that is one of RDS services, it is possible to extract only desired information from transmitted text information for 64 characters and display the desired information. Group 11A data included in Radio Text Plus includes display range information composed of a start marker and a length marker, and character information corresponding to the character position information for a range prescribed by the start marker and the length marker are extracted. Thus, only pieces of information such as a music name and an artist name can be displayed.

The broadcast receiving device described in Patent Literature 1 discloses an invention in which when a character information corresponding to a last position of a character range indicated by a start marker and a length marker is detected, character information to be displayed are determined. The invention allows quick output and display of character information without receiving all of character information for 64 characters.

### CITATION LIST

### Patent Literature

Patent Literature 1: Japanese Patent Laid-Open No. 2008-22343

### SUMMARY OF INVENTION

### Technical Problem

To change the content of character information to be sent in RDS (for example, if a music name or an artist name has been changed), a broadcast station sends the group 2A data while switching a text A/B flag included therein. When a change in that flag is detected on the receiver side, character information in a memory is reset, and new character information is sequentially stored so that new character information is displayed.

If a group 2A data is not received because of bad receiving condition of radio waves, or if a broadcast station sends data with a text A/B flag unswitched, the broadcast receiving device side cannot detect a change in text A/B flag, and erroneous information including a mixture of old character information and new character information is displayed.

The present invention has been made against the above-described background. An object of the present invention is to provide a broadcast receiving device and method capable of ensuring detection of a change in character information sent from a broadcast station and preventing erroneous display.

### Solution to Problem

A broadcast receiving device according to one aspect of the present invention is configured to include a decoding unit that decodes broadcast radio waves, in which program information and data information are multiplexed, into character information included in the data information and character position information indicating positions of the character information, a storage unit that stores the decoded character information associated with the character position information, a character information comparison unit that compares first character information included in the received broadcast radio waves with second character information stored in the storage unit and has the same character position information as the first character information, a character information extraction unit that extracts the character information stored in the storage unit and, if the first character information and the second character information are different, deletes the character information stored in the storage unit, and a display unit that outputs and displays the character information extracted by the character information extraction unit.

As will be described below, the present invention has other aspects. Thus, the disclosure of the invention is intended to provide some aspects of the present invention and is not intended to limit the scope of the invention described and claimed herein.

### BRIEF DESCRIPTION OF DRAWINGS

FIG. 1 is an explanatory diagram showing the configuration of a broadcast receiving device according to an embodiment of the present invention.

FIG. 2 is an explanatory diagram showing the data structure of an RDS group 2A.

FIG. 3 is an explanatory diagram showing the data structure of an RDS group 3A.

FIG. 4 is an explanatory diagram showing the data structure of an RDS group 11A.

FIG. 5 is a flow chart showing the operation of the broadcast receiving device upon receipt of group 11A data.

FIG. 6 is a flow chart showing the operation of the broadcast receiving device upon receipt of group 2A data.

FIG. 7 is an explanatory diagram showing a data processing method for Radio Text Plus in normal condition.

FIG. 8 is an explanatory diagram showing a conventional data processing method for Radio Text Plus in a condition where reception is poor.

FIG. 9 is an explanatory diagram showing a data processing method for Radio Text Plus according to the embodiment of the present invention.

### DESCRIPTION OF EMBODIMENT

A detailed description of the present invention will be given below. However, the detailed description below and the accompanying drawings are not intended to limit the invention.

A broadcast receiving device according to the present invention is configured to include a decoding unit that decodes broadcast radio waves, in which program information and data information are multiplexed, into character information included in the data information and character position information indicating positions of the character information, a storage unit that stores the decoded character information associated with the character position information, a character information comparison unit that compares first character information included in the received broadcast radio waves with second character information stored in the storage unit and has the same character position information as the first character information, a character information extraction unit that extracts the character information stored in the storage unit and, if the first character information and the second character information are different, deletes the character information stored in the storage unit, and a display unit that outputs and displays the character information extracted by the character information extraction unit.

With this configuration, if received character information is different from character information in the storage unit, it is determined that the content of character information has been updated, and the old character information stored in the storage unit is deleted. This ensures prevention of display of erroneous information.

In the broadcast receiving device according to the present invention, the data information includes display range information indicating the character position information corresponding to the character information to be output and displayed, and the character information extraction unit extracts the character position information indicated by the display range information from among the character information stored in the storage unit. With this configuration, only necessary information of received character information is selected and displayed, which can enhance the display effect.

In the broadcast receiving device according to the present invention, the display range information comprises a plurality of display range information, and the character information extraction unit extracts the character information corresponding to the character position information indicated by each of the display range information when the corresponding character information is stored in the storage unit. With this configuration, it is possible to immediately display each tag information if there are a number of tag information to be displayed. This eliminates a situation in which nothing is displayed until all of the character information is acquired.

The display range information may include head position information indicating a number of a head character of the piece of character information to be output and displayed and length information indicating length of character information to be displayed.

A broadcast receiving method according to the present invention is configured to include a decoding step of decoding broadcast radio waves, in which program information and data information are multiplexed, into character information included in the data information and character position information indicating positions of the character information, a step of storing the decoded character information associated with the character position information in a storage unit, a character information comparison step of comparing first character information included in the received broadcast radio waves with second character information stored in the storage unit and has the same character position information as the first character information, a character information extraction step of extracting the character information stored in the storage unit and, if the first character information and the second character information are different, deleting the character information stored in the storage unit, and a display step of outputting and displaying the character information extracted in the character information extraction step. This configuration also has the advantage of ensuring prevention of display of erroneous display.

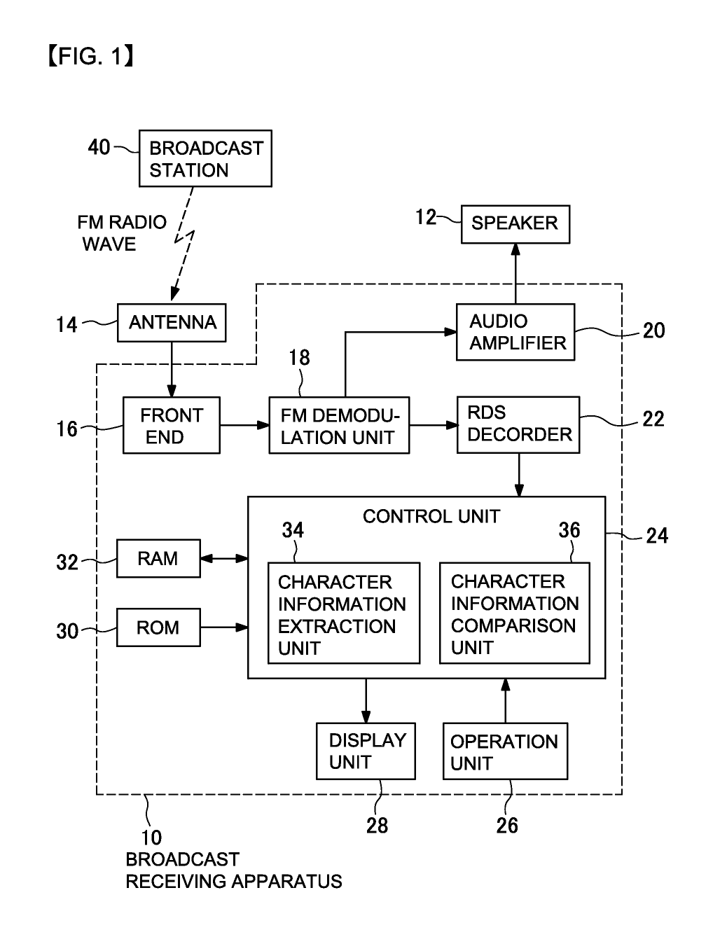

A broadcast receiving device according to one embodiment of the present invention will be described below with reference to the drawings. FIG. 1 is an explanatory diagram showing the configuration of a broadcast receiving device 10. The broadcast receiving device 10 is used as an in-car FM radio and is mounted on a vehicle together with a speaker 12 and an antenna 14.

The broadcast receiving device 10 is configured to include a front end 16, an FM demodulation unit 18, an audio amplifier 20, an RDS decoder 22 as a decoding unit, a control unit 24, an operation unit 26, a display unit 28, a ROM 30, and a RAM 32 as a storage unit.

The antenna 14 receives FM radio waves from a broadcast station 40. In the FM radio waves, program information indicating the content of a radio broadcast program (audio signals of a radio broadcast) and data information compliant with the RDS standard are superimposed. The front end 16 converts FM radio waves corresponding to a selected frequency among FM radio waves received by the antenna 14 into intermediate frequency signals on the basis of a frequency control signal (not shown) from the control unit 24 and sends the FM radio waves to the FM demodulation unit 18.

The FM demodulation unit 18 demodulates the intermediate frequency signals from the front end 16 and divides the demodulated signals into program information and data information compliant with the RDS standard. Of these information, the program information is sent to the audio amplifier 20 and amplified, and is then sent to a plurality of speakers 25 installed in the vehicle. Thus, a radio broadcast is output from the speakers 25.

The RDS decoder 22 decodes demodulated signals corresponding to the data information from the FM demodulation unit 18 and extracts various information including Radio Text and a traffic message. The information extracted by the RDS decoder 22 is sent to the control unit 24.

The control unit 24 includes a processing unit such as a CPU (Central Processing Unit) and controls the operation of the units constituting the broadcast receiving device 10. The control unit 24 also stores character information included in data from the RDS decoder 22 in the RAM 32 and includes a character information extraction unit 34 which extracts character information stored in the RAM 32 and a character information comparison unit 36 which compares character information from the RDS decoder 22 with character information stored in the RAM 32.

The operation unit 26 is, for example, input means such as a touch panel or an operation button installed in an FM radio main body or a dedicated remote control and is used to select a program to be listened to. The display unit 28 is, for example, an LCD panel and outputs and displays the name of a selected broadcast station and character information included in data information.

The ROM 30 stores a program to be executed by the control unit 24 and data such as various settings, and the program is read out by the control unit 24 when the program is to be executed. The RAM 32 is used as a temporary storage area for data when the control unit 24 performs predetermined arithmetic processing and temporarily stores various information included in Radio Text and Radio Text plus.

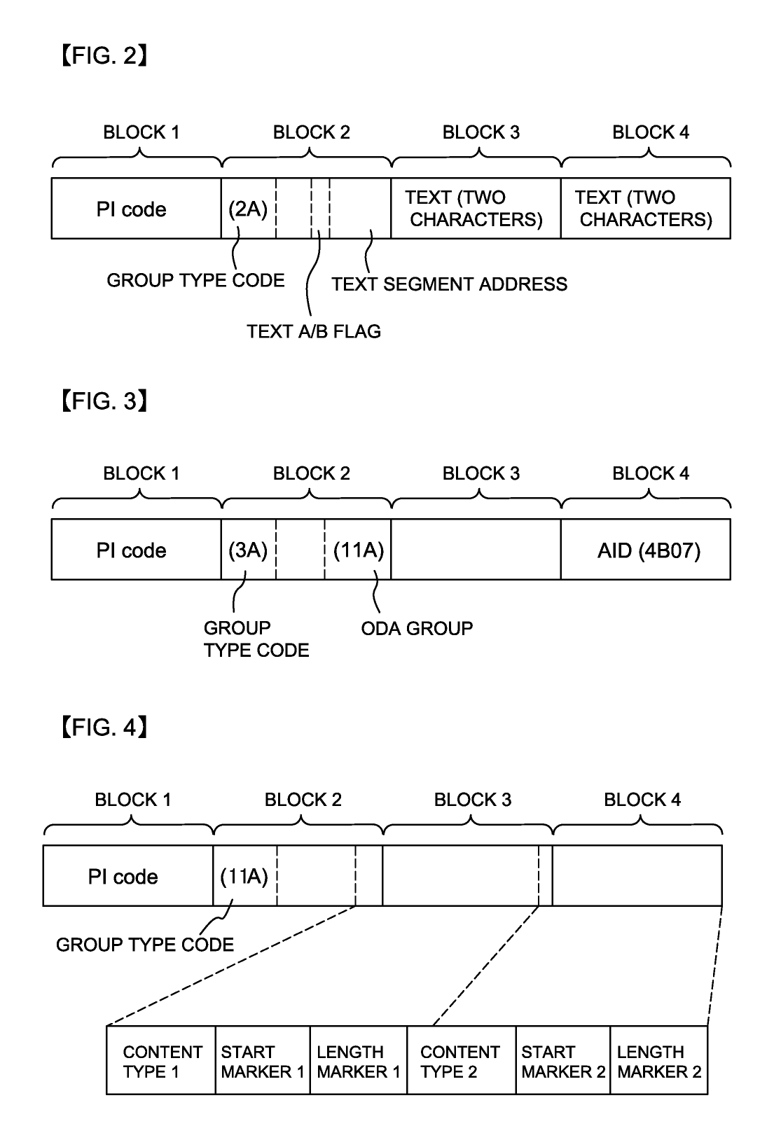

FIG. 2 shows the data format of a group of the type 2A of RDS (hereinafter referred to as a “group 2A”). Note that a data unit compliant with RDS is composed of four blocks, and each block includes an information word and a check word. Check words are not shown.

Referring to FIG. 2, a first block (block 1) includes a program identification (PI) code. A second block (block 2) includes a group type code indicating a group type (2A), a text A/B flag of one bit, and a text segment address code of four bits. The value of the text A/B flag changes when the content of text information sent from the broadcast station 40 (e.g., a music name or an artist name) has been changed. The text segment address code is character position information indicating the ordinal position of character information for four characters (one set) to be sent in Radio Text composed of 64 characters (16 sets).

Third and fourth blocks (block 3 and block 4) of the group 2A each include Radio Text information for two characters, and text information for a total of four characters are written in the third and fourth blocks. For this reason, character information for 64 characters is transmitted in data as 16 groups 2A. Note that all of the character information for the 64 characters may be repeatedly sent or only some (e.g., information for first to tenth characters) of the character information may be repeatedly sent. In either case, the positions of character information to be sent can be identified by the text segment address code described above.

FIG. 3 shows the data format of the type 3A of RDS. In block 2, information of “3A” is written as a group type code. In block 4, a value of “4B07” meaning an AID (Application Identification) indicating Radio Text Plus is written. At the end of block 2, information of “11A” specifying an ODA (Open Data Application) group is written. The ODA group here refers to the name of a group that a broadcast station can freely define the content of the group. By specifying the AID as described above, a group 11A specified by the ODA group can be sent with information of Radio Text Plus included.

FIG. 4 shows the data format of the type 11A of RDS. In block 1, a PI code is written. In block 2, data of “11A” indicating the type of a group is written.

The group 11A contains two sets of three types of data, a content type, a start marker as head position information, and a length marker as length information.

The content type is data indicating the type of tag information meant by text information sent by data broadcasting, and 64 types of tag information are defined in advance. For example, a content type of “1” indicates a music name, and a content type of “4” indicates an artist name.

The start marker indicates the position of a start (head) character of character information of a type indicated by the content type, and the length marker indicates the length of the character information. Note that the count value of the start marker is defined as (a character number shown in Radio Text−1), and the actual length of the character information is defined as (the count value of the length marker+1). For example, if a start marker is “0,” and a length marker is “10,” the markers show that corresponding text information is information for 11 characters starting from a first character. It is noted that information as a start marker and a length marker correspond to “display range information” in the present invention.

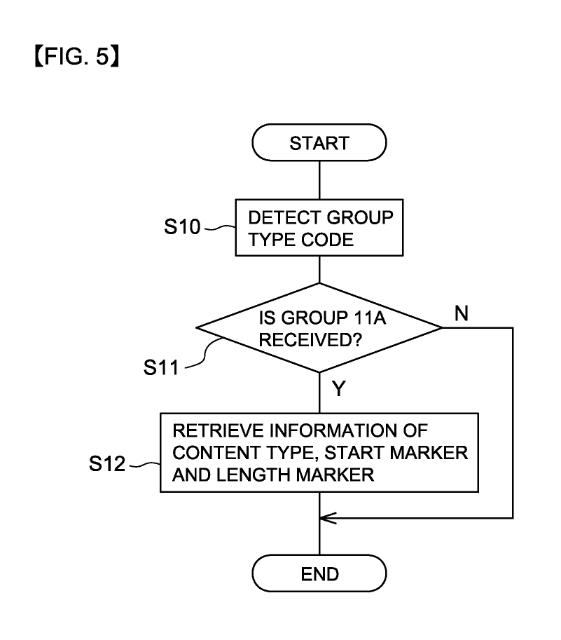

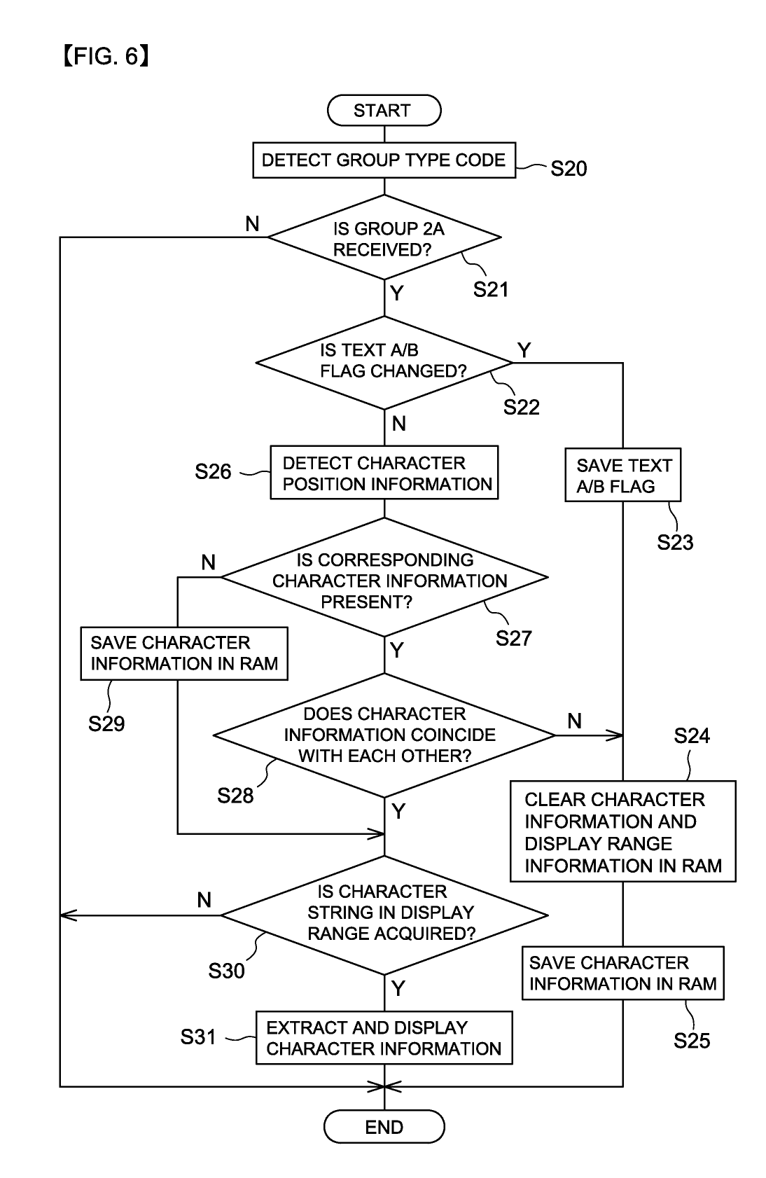

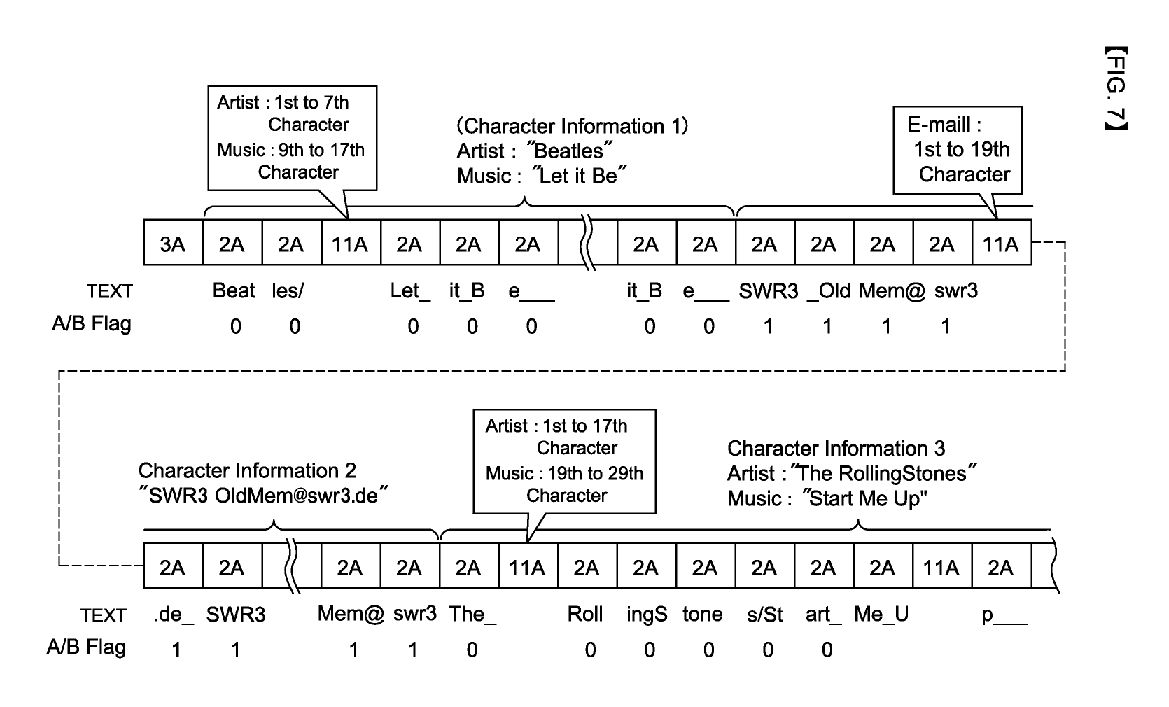

A process of extracting character information in the character information extraction unit 34 and character information comparison unit 36 will be described with reference to the flow charts in FIGS. 5 and 6. FIG. 5 is a flow chart showing a process of setting display range information indicating a display range for a received character string. First, the character information extraction unit 34 detects a group type code of data sent from the RDS decoder 22 (S10) and checks whether the detected group type code is 11A (S11). If data as a group 11A is detected, the character information extraction unit 34 acquires information as a content type, a start marker, and a length marker and stores these information in the RAM 32 (S12).

FIG. 6 is a flow chart showing a procedure upon receipt of data as a group 2A. The character information extraction unit 34 detects a group type code of data sent from the RDS decoder (S20) and checks whether the detected group type code is 2A (S21). If the received data is a group 2A, the character information extraction unit 34 shifts to step S22. Otherwise, the character information extraction unit 34 ends the process.

In step S22, the character information extraction unit 34 detects whether a text A/B flag included in the data as the group 2A coincides with a text A/B flag stored in the RAM 32 (i.e., character information sent from the broadcast station has been changed).

If the text A/B flags do not coincide with each other, the character information extraction unit 34 shifts to step S23 to store data as the new text A/B flag in the RAM 32 (S23). To update character information to be displayed, the character information extraction unit 34 deletes character information and display range information stored in the RAM 32 (S24), and saves character information for four characters included in the newly received data as the group 2A in the RAM 32 (S25).

On the other hand, if the received text A/B flag coincides, the character information extraction unit 34 shifts to step S26. The character information extraction unit 34 acquires a text segment address (character position information) and character information included in the group 2A. The character information comparison unit 36 detects whether character information corresponding to the acquired character position information is stored in the RAM 32 (S27). If a result of the detection shows that there is no corresponding character information, the character information comparison unit 36 determines that the acquired character information is newly acquired character information and shifts to step S29. The character information comparison unit 36 saves the received character information in the RAM 32 (S29).

If character information corresponding to the received character position information is stored in the RAM 32, the character information comparison unit 36 checks whether the newly received character information coincides with the character information stored in the RAM 32 (S28). If the character string is detected to be different as a result, the character information comparison unit 36 determines that character information sent from the broadcast station has been changed and deletes the character information and display range information stored in the RAM 32 (S24). The character information extraction unit 34 saves, in the RAM 32, the character information for four characters included in the data as the newly received group 2A (S25). In this manner, the character information to be displayed can be changed.

On the other hand, if the received character information coincides with the character information stored in the RAM 32, the character information extraction unit 34 determines whether character information corresponding to character positions defined by the display range information is stored in the RAM (S30). If a result of the determination shows that all of the character information to be displayed are stored in the RAM 32, the character information extraction unit 34 extracts the corresponding character information from the RAM 32 and outputs and displays the character information on the display unit 28 (S31). On the other hand, if not all of the character information are stored in the RAM 32, the character information extraction unit 34 ends the process without outputting and displaying character information.

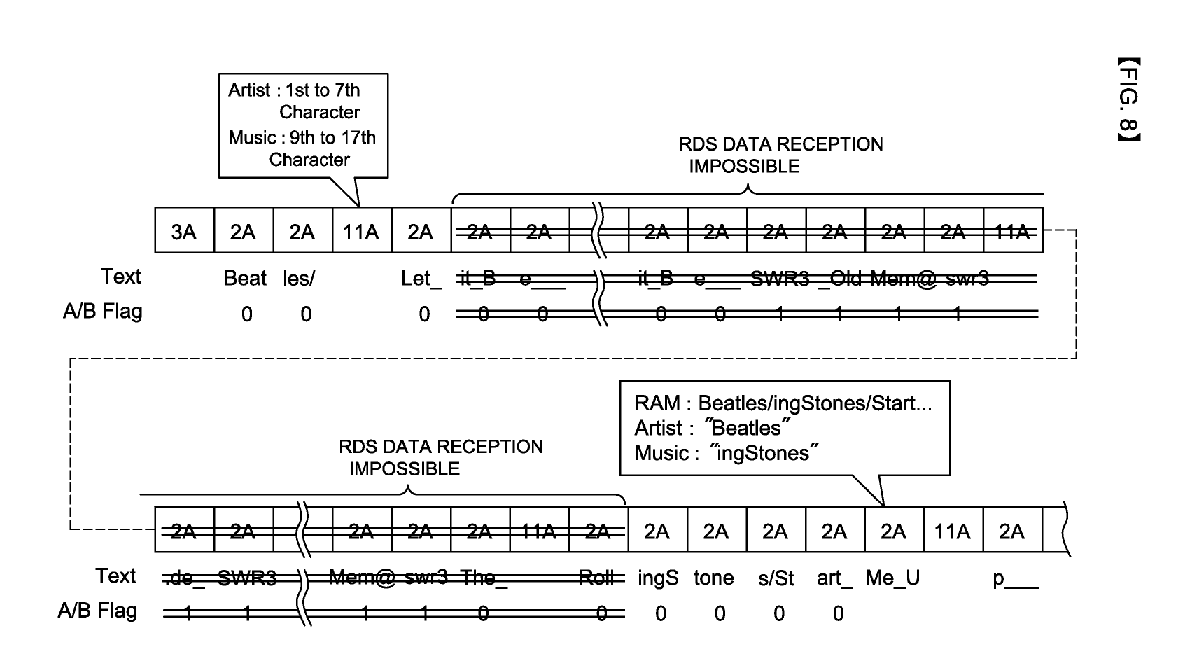

Action of the broadcast receiving device with the above-described configuration will be described below. FIG. 7 shows a data processing method for Radio Text Plus in normal times. In the example of FIG. 7, text information (text 1) composed of an artist name of “Beatles” and a music name of “Let it Be” is displayed, text information (text 2) of “SWR3 OldMem@swr3.de” is displayed, and text information (text 3) composed of an artist name of “The RollingStones” and a music name of “Start Me Up” is displayed.

First, data as a group 3A is received, and it is determined that data of Radio Text Plus is to be processed. After that, data as a group 2A or a group 11A are sequentially received. Data as a group 2A includes character information for four characters such as “Beat” or “les/,” a text A/B flag indicating that the content of text has been changed, and character position information indicating the position of the character information (a text segment address). Note that in the examples of FIG. 7 to FIG. 9, data indicated by the underscore “_” means a blank.

In FIG. 7, data as a group 11A that is the fourth to be received (data that is received after data as a group 2A including character information of “les/”) includes information of “1” as start marker 1 and information of “7” as length data 1 corresponding to a content type for displaying an artist name and means that information represented by first to seventh characters is an “artist name.” The same data as the group 11A also includes information of “9” as start marker 2 and information of “9” as length data 1 corresponding to a content type for displaying a music name and means that information represented by ninth to 17th characters is a “music name.”

If character information received as text 1 is “Beatles/Let it Be,” the first to seventh characters ‘Beatles’ and the ninth to 17th characters ‘Let it Be’ are extracted as an artist name and a music name, respectively, and are displayed on the display unit 28. Note that although the character information received as text 1 and stored in the RAM 32 may include information other than “Beatles” and “Let it Be” (omitted for simplicity in FIG. 7 to FIG. 9), since display range information is defined as described above, the character information other than the first to seventh characters ‘Beatles’ and the ninth to 17th characters ‘Let it Be’ is not displayed on the display unit 28.

When text information (text 2) different from text 1 is to be sent, a text A/B flag is switched from 0 to 1. With this switch, the receiving side can detect that sent character information has changed. It is detected from data as a group 11A that mail address information is included as first to 19th characters, and the character string “SWR3 OldMem@swr3.de” as corresponding character information is output and displayed.

After that, if text information (text 3) different from text 2 is to be sent, the text A/B flag is switched from 1 to 0. It is detected from data as a group 11A that artist name information is included as first to 17th characters and that music name information is included as 19th to 29th characters. The first to 17th characters ‘The RollingStones’ and the 19th to 29th characters ‘Start Me Up’ are extracted as an artist name and a music name, respectively, and are output and displayed on the display unit 28.

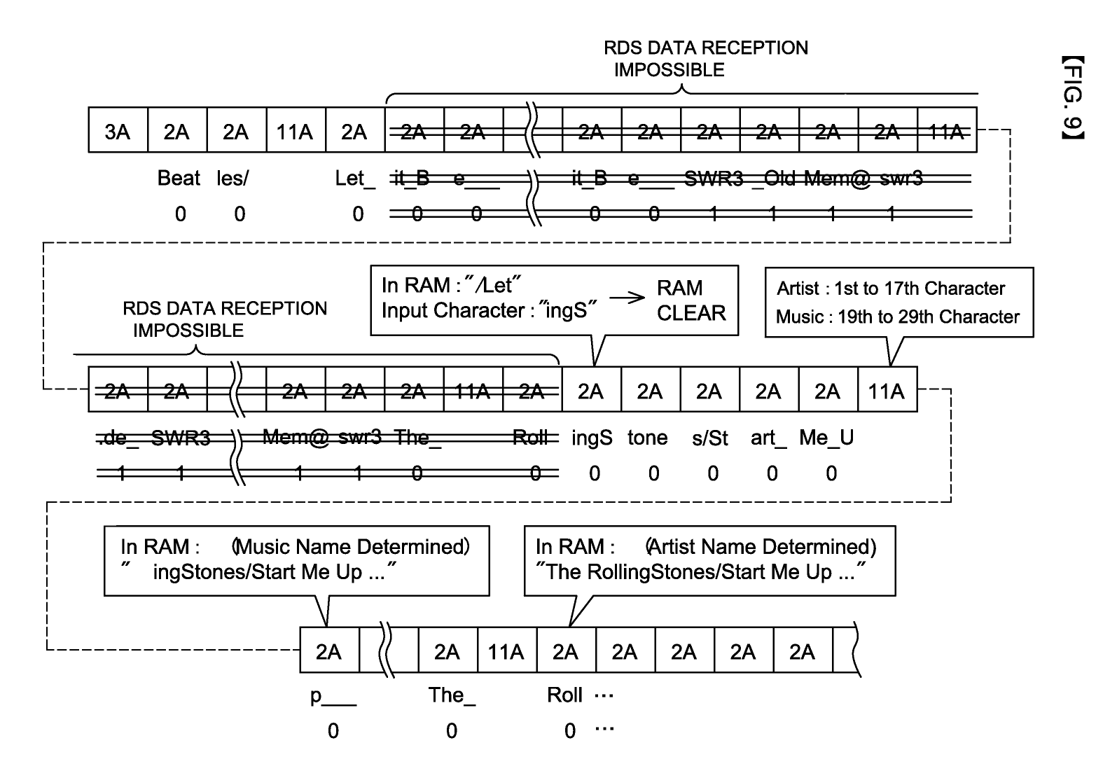

If reception of data broadcasting becomes worse, and RDS data as groups 2A corresponding to text 2 cannot be received, as shown in FIG. 8, a text A/B flag corresponding to data as a group 2A (corresponding to text 3) to be received next is 0. Accordingly, a conventional receiving device cannot detect that text information is new. In this case, character information stored in the RAM 32 is “Beatles/ingStones/Start . . . .” Since first to seventh characters ‘Beatles’ and ninth to 17th characters ‘ingStones’ are output and displayed as an artist name and a music name, respectively, erroneous character information is output. This situation also applies to a case where a broadcast station sends information without changing a text A/B flag.

For this reason, the broadcast receiving device according to the present embodiment is configured to compare received character information with character information stored in the RAM 32 and detect whether sent and received character information has changed. FIG. 9 shows a data processing method for Radio Text Plus according to the present embodiment. If a data as groups 2A corresponding to text 2 cannot be received at all, and character information as a group 2A received next is “ingS” (character position information is “3” (corresponding to ninth to 12th characters)), of character information of “Beatles/Let/” stored in the RAM 32, information of “Let/” as the ninth to 12th characters is compared with the newly received character information of “ingS”.

Since a result of the comparison shows that the two character information are different, the character information comparison unit 36 detects that character information different from text 1 is sent and received, deletes character information and display range information in the RAM 32, and acquires new character information and display range information. With this configuration, even if character information cannot be received or if a text A/B flag is not switched by a broadcast station, it is possible to ensure to prevent display of erroneous information.

After that, data as a group 11A is received, and it is detected that artist name information is included as first to 17th characters and that music name is included as 19th to 29th characters. After that, when a data as groups 2A are received, and character information in the RAM 32 is “ . . . ingStones/Start Me Up,” it is detected that information as the 19th to 29th characters is determined, and a music name “Start Me Up” is output and displayed first. When a data as groups 2A are received, and the information in the RAM is “The RollingStones/Start Me Up . . . ,” information as first to 17th characters is determined, and an artist name “The RollingStones” is output and displayed.

As described above, if there are number of character information to be displayed, necessary character information can be immediately displayed by displaying character information when the character information corresponding to the display range information is determined.

The embodiment of the present invention has been illustrated above. The scope of the present invention, however, is not limited to this, and the embodiment can be changed and modified within the scope of the claims to suit an intended purpose.

For example, although information such as a music name and an artist name are displayed in the above embodiment, the present invention is not limited to this. For example, the present invention can also be applied to a case where information such as location information of a shop or sports result information being broadcast on the radio is sent by group 2A data.

Although the embodiment has been described in the context of an in-car FM radio, the present invention is not limited to this. For example, the present invention can be applied to any other electronic device such as a stationary or mobile radio, a cellular phone, or a television.

A presently preferred embodiment of the present invention has been described above. It is understood that various modification can be made to the present embodiment. It is intended that the scope of the appended claims includes all such modifications within the true spirit and scope of the present invention.

### INDUSTRIAL APPLICABILITY

As described above, a broadcast receiving device according to the present invention has the advantage of ensuring prevention of display of erroneous information by resetting character information stored in a storage unit if received character information and the character information stored in the storage unit do not coincide with each other. The broadcast receiving device can be applied to an electronic device such as an FM radio and is useful.

### REFERENCE SIGNS LIST

10 broadcast receiving device
14 antenna
16 front end
18 FM demodulation unit
22 RDS decoder
24 control unit
28 display unit
30 ROM
32 RAM
34 character information extraction unit
36 character information comparison unit

1. A broadcast receiving device comprising:
a decoding unit that decodes broadcast radio waves, in which program information and data information are multiplexed, into character information included in the data information and character position information indicating positions of the character information;
a storage unit that stores the decoded character information associated with the character position information;
a character information comparison unit that compares first character information included in the received broadcast radio waves with second character information stored in the storage unit and has the same character position information as the first character information;
a character information extraction unit that extracts the character information stored in the storage unit and, if the first character information and the second character information are different, deletes the character information stored in the storage unit; and
a display unit that outputs and displays the character information extracted by the character information extraction unit.

2. The broadcast receiving device according to claim 1, wherein the data information includes display range information indicating the character position information corresponding to the character information to be output and displayed, and
the character information extraction unit extracts the character information corresponding to the character position information indicated by the display range information from among the character information stored in the storage unit.

3. The broadcast receiving device according to claim 2, wherein the display range information comprises a plurality of display range information, and the character information extraction unit extracts the character information corresponding to the character position information indicated by each of the display range information when the corresponding character information is stored in the storage unit.

4. The broadcast receiving device according to claim 2, wherein the display range information includes head position information indicating a number of a head character of the character information to be output and displayed and length information indicating length of character information to be displayed.

5. A broadcast receiving method comprising:
a decoding step of decoding broadcast radio waves, in which program information and data information are multiplexed, into character information included in the data information and character position information indicating positions of the character information;
a step of storing the decoded character information associated with the character position information in a storage unit;
a character information comparison step of comparing first character information included in the received broadcast radio waves with second character information stored in the storage unit and has the same character position information as the first character information;
a character information extraction step of extracting the character information stored in the storage unit and, if the first character information and the second character information are different, deleting the character information stored in the storage unit; and
a display step of outputting and displaying the character information extracted in the character information extraction step.
